(19) United States
(12) Patent Application Publication
(10) Pub. No.: US 2018/0003021 A1
(43) Pub. Date: Jan. 4, 2018

(54) PROPPANT SUSPENSION IN SHALE FRACTURES

(71) Applicant: Baker Hughes, a GE company, LLC, Houston, TX (US)

(72) Inventors: James B. Crews, Willis, TX (US); Naima Bestaoui-Spurr, The Woodlands, TX (US)

(73) Assignee: Baker Hughes, a GE company, LLC, Houston, TX (US)

(21) Appl. No.: 15/708,856

(22) Filed: Sep. 19, 2017

Related U.S. Application Data
(63) Continuation-in-part of application No. 14/225,526, filed on Mar. 26, 2014.
(60) Provisional application No. 61/808,998, filed on Apr. 5, 2013.

(51) Int. Cl. E21B 43/267; C09K 8/80; C09K 8/68

(52) U.S. Cl. CPC E21B 43/267; C09K 8/685; C09K 8/80

(57) ABSTRACT

Proppants may be effectively placed within a hydraulic fracture of a subterranean formation by hydraulically fracturing the subterranean formation to form fractures in the formation using a fracturing fluid where proppants are introduced into the fractures during and/or after hydraulically fracturing the formation. During and/or after hydraulically fracturing the subterranean formation, a plurality of ribbons are introduced into the fractures, where the ribbons contact and inhibit or prevent the proppants from settling by gravity within the fractures; the ribbons comprise a crosslinked gel. Finally, the fractures are closed against the proppants.

### CROSS-REFERENCE TO RELATED APPLICATION

This application is a continuation-in-part patent application of U.S. Ser. No. 14/225,526 filed Mar. 26, 2014, which in turn claims the benefit of U.S. Provisional Patent Application Ser. No. 61/808,998 filed Apr. 5, 2013; all of which are incorporated herein by reference in their entireties.

### TECHNICAL FIELD

The present invention relates in one non-limiting embodiment to methods and compositions to fracture subterranean formations, and more particularly relates, in another non-restrictive version, to methods and compositions for inhibiting or preventing proppants from settling within a hydraulic fracture, which compositions can be readily pumped into the fracture.

### TECHNICAL BACKGROUND

Hydraulic fracturing of subterranean formations to extract hydrocarbons such as oil and gas is well known. Hydraulic fracturing (or “fracking”) involves a stimulation treatment performed on oil and gas wells in low-permeability reservoirs. Specially engineered fracturing fluids are pumped at high pressures and rates into the reservoir interval to be treated, causing a vertical fracture to open. The two wings of the fracture extend away from the wellbore in opposing directions according to the natural stresses within the formation. Proppant, which in one non-limiting embodiment may be grains of sand, aluminum oxide, etc. of a particular size, is mixed with the treatment fluid to keep the fracture open when the treatment is complete and the hydraulic pressure is removed. Hydraulic fracturing creates high-conductivity communication with a large area of formation and bypasses damage that may exist in the near-wellbore area.

Recently the combination of directional drilling and hydraulic fracturing has made it economically possible to produce oil and gas from new and previously unexploited ultra-low permeability hydrocarbon bearing lithologies (such as shale) by placing the wellbore laterally so that more of the wellbore, and the series of hydraulic fracturing networks extending therefrom, is present in the production zone permitting production of more hydrocarbons as compared with a vertically oriented well that occupies a relatively small amount of the production zone; see FIGS. 1A and 1B. “Laterally” is defined herein as a deviated wellbore away from a more conventional vertical wellbore by directional drilling so that the wellbore can follow the oil-bearing strata that are oriented in a non-vertical plane or configuration. In one non-limiting embodiment, a lateral wellbore is any non-vertical wellbore. It will be understood that all wellbores begin with a vertically directed hole into the earth, which is then deviated from vertical by directional drilling such as by using whipstocks, downhole motors and the like. A wellbore that begins vertically and then is diverted into a generally horizontal direction may be said to have a “heel” at the curve or turn where the wellbore changes direction and a “toe” where the wellbore terminates at the end of the lateral or deviated wellbore portion. In one non-limiting embodiment, the “sweet-spot” of the hydrocarbon bearing reservoir is an informal term for a desirable target location or area within an unconventional reservoir or play that represents the best production or potential production. The combination of directional drilling and hydraulic fracturing has led to the so-called “fracking boom” of rapidly expanding oil and gas extraction in the US beginning in about 2003.

Most fractures have a vertical orientation as shown schematically in FIG. 1A which illustrates a wellbore 10 having with a vertical portion 12 and a lateral portion 14 drilled into a subterranean formation 16. Through hydraulic fracturing a fracture 28 having an upper fracture 18 and a lower fracture 20 have been created where there is fluid communication between upper and lower fractures 18 and 20, and proppant 22 is shown uniformly or homogeneously distributed in the fracturing fluid 24 of the upper and lower fractures 18 and 20. However, over long fracture closure times, and as the viscosity of the fracturing fluid decreases after fracturing treatments, the proppants 22 settles in the lower fracture 20 and the upper fracture 18 closes without proppant 22 to keep it open, thus operators lose the upper fracture 18 conductivity as schematically illustrated in FIG. 1B. The upper fracture 18 may be the location of the sweet spot horizon 26 of the shale play of the formation 16. The sweet-spot horizon 26 is defined herein as the horizon with in the shale interval to be hydraulically fractured that will produce the most hydrocarbon compared to the shale horizons hydraulically fractured directly above and below.

The traditional fluid technology developed for conventional hydraulic fracturing has had limited success for fracturing shale formations. The fluid developmental trend over the past 40 years for newer and better crosslinked polymer systems has been abruptly halted and in many geographic areas replaced by simple and common slickwater. Slickwater or slick water fracturing is a method or system of hydro-fracturing which involves adding chemicals to water to increase the fluid flow. Such fluid can be pumped down the well-bore fast, such as at a rate of 100 bbl/min to fracture the shale. Without using slickwater the top speed of pumping is often slower, such as 60 bbl/min. The process involves injecting water containing friction reducers, usually a polyacrylamide or other polymer. Over the past decade, all types of hybrid fluids have been evaluated for shale treatments including the mix and match of slickwater with relatively low to relatively high viscosity polymeric systems.

Efforts have been made to make the proppant pack within a fracture more uniform. U.S. Pat. No. 9,010,424 to G. Agrawal, et al. and assigned to Baker Hughes Incorporated involves disintegrative particles designed to be blended with and pumped with typical proppant materials, e.g. sand, ceramics, bauxite, etc., into the fractures of a subterranean formation to prop them open. With time and/or change in wellbore or environmental condition, these particles will either disintegrate partially or completely, in non-limiting examples, by contact with downhole fracturing fluid, formation water, or a stimulation fluid such as an acid or brine. Once disintegrated, the proppant pack within the fractures will lead to greater open space enabling higher conductivity and flow rates. The disintegrative particles may be made by compacting and/or sintering metal powder particles, for instance magnesium or other reactive metal or their alloys. Alternatively, particles coated with compacted and/or sintered nanometer-sized or micrometer sized coatings could also be designed where the coatings disintegrate faster or slower than the core in a changed downhole environment.

Improvements are always needed in the driller's ability to increase and maintain the permeability of a proppant pack within a hydraulic fracture to improve the production of hydrocarbons from the subterranean formation.

### SUMMARY

There is provided in one non-limiting embodiment a method of placing proppants in a hydraulic fracture of a subterranean formation, where the method includes hydraulically fracturing the subterranean formation to form fractures in the formation using a fracturing fluid, and during and/or after hydraulically fracturing the subterranean formation, introducing proppants into the fractures. The method further involves during and/or after hydraulically fracturing the subterranean formation, introducing a plurality of ribbons into the fractures, the ribbons contacting and inhibiting or preventing the proppant from settling by gravity within the fractures, where the ribbons comprise a gel; optionally a crosslinked gel. Finally the method includes closing the fractures against the proppants.

There is additionally provided in one non-restrictive version, a fluid for placing proppants in a hydraulic fracture of a subterranean formation, where the fluid includes a carrier fluid, a plurality of proppants, and a plurality of ribbons configured to contact and inhibit or prevent the proppant from settling by gravity within hydraulic fractures in the subterranean formation, where the ribbons comprise a gel.

### BRIEF DESCRIPTION OF THE DRAWINGS

FIG. 1A is a schematic illustration of a wellbore with an upper and lower fracture depicting proppant uniformly distributed in a fracturing fluid in the upper and lower fracture, which is under hydraulic pressure to keep it open;

FIG. 1B is a schematic illustration of a wellbore with an upper and lower fracture depicting proppant having settled to the bottom of the lower fracture, the upper and lower fractures having closed, where the upper fracture is substantially completely closed due to the lack of proppant therein;

FIG. 2 is a schematic illustration of an upper fracture where proppant and ribbons are generally uniformly or homogeneously distributed in a fracturing fluid under pressure therein and the proppants are settling by gravity on the ribbons;

FIG. 3 is a schematic illustrations of the upper fracture of FIG. 2 after the fracturing fluid pressure has been removed, the fracture has closed, and proppant pillars have been formed to prop open the fracture faces from one another;

FIG. 4 is a schematic illustration of an upper fracture where proppant and a ribbon are distributed in a fracturing fluid under pressure therein and the proppants are settling by gravity on the ribbon, where the ribbon is optionally wedged between ledges on opposing fracture faces, and where optionally at least some of the proppants are at least partially or entirely within the ribbon; and

FIG. 5 is a schematic illustration of the upper fracture of FIG. 4 where the fracturing fluid pressure has been removed, the fracture has closed, and a proppant pillar has been formed adjacent the ribbon.

It will be appreciated that the various Figures are not necessarily to scale and that certain features have been exaggerated for clarity and do not necessarily limit the features of the invention. For instance, the absolute and relative sizes of the fracture widths, proppant sizes, and ribbon sizes have been exaggerated to illustrate the methods and fluids described herein.

### DETAILED DESCRIPTION

It has been discovered that gel ribbons having a wide variety of physical shapes and forms may be transported with proppant into a hydraulic fracture and used to catch, hold, snag, wedge and otherwise engage proppants and temporarily hold them in place within the fracture so that when pumping has been completed and the fracture closes, the fracture faces close against relatively uniformly distributed proppant pillars or placements to provide a relatively heterogeneous and uniform improved permeability proppant pack in the fracture as contrasted with an otherwise identical case where no ribbons are used.

The ribbons are all functional or functionalized, to have at least two functions or abilities: (1) they must be transportable with a carrier fluid (which may be, but is not necessarily limited to, a fracturing fluid) downhole to a subterranean formation and a hydraulic fracture within the subterranean formation. The ribbons may be part of, contained in, suspended in, dispersed in, placed in, and otherwise comprised by the fracturing fluid that fractures the formation. Alternatively the ribbons may be introduced subsequently to formation of the hydraulic fracture in a subsequent fluid. Additionally the ribbons must have (2) the function or ability to interact with the fracture face (fractured face of the formation) such as by dragging, skidding, snagging, catching, poking, wedging or otherwise engaging the sides of the fracture while also snagging, catching, holding, wedging, supporting, and otherwise engaging the proppant, which is also in the fluid (or alternatively introduced separately into the fracture), thereby holding the proppant in place relative to the fracture face to inhibit and/or prevent and/or be a localized support location for the proppant from settling into the lower portion of the fracture by gravity. In one non-limiting embodiment a localized support location is defined to mean as in a concentration distribution of every 2 inches, or every 4 inches, or even up to every 10 inches apart from each other. The ribbons will be localized in positions where proppant that begins to settle will only settle so far until they reach a ribbon position where the proppant will come to rest upon and not settle any further. Thus the ribbon is a localized support location that can vary in distances a part from each other.

The ribbons are designed and configured to have a geometry and a composition to interact with fracture walls once treatment is completed, that is, when the treatment pumps are stopped and treatment fluid flow into hydraulic fractures ceases. The functional design of the ribbons configures them to interact with the fracture walls to create distributed support structures within the hydraulic fracture where each ribbon will physically collect settling proppant particles at each ribbon locale. In one non-limiting embodiment, ribbons in this case means many distributed anti-settling agents configured to act as support structures, where “support structure” means a physical object to obstruct, prevent, restrict, and otherwise control proppant from sedimentation to the bottom of the hydraulic fracture by gravity. In one non-limiting embodiment the fractures are oriented vertically, or to a vertical degree i.e. where proppant settling by gravity is undesirable.

It will be appreciated that it is not necessary for the ribbon to hold the proppant fast to the fracture face in the sense of adhering it or fixing it in place. When the fracture closes on the proppant, that is the force and process that holds the proppant in a fixed place and location. The ribbon only needs to catch, snag, hold, and/or support the proppant sufficiently to inhibit or prevent it from settling by gravity. It is acceptable if the ribbon holds the proppant fast to the fracture face, but it is not necessary because it is expected that as the fracture closes and the space between the opposing fracture walls narrows the proppants may be moved slightly into their permanent places under closure pressure. In other words, the proppants may be temporarily suspended for a time before the fracture closes long enough for their motion downward is inhibited or prevented to keep them from settling in the bottom of the fracture. Thus the ribbons must be transportable in a treatment fluid, but also have a physical shape or combination with physical property that interacts with formation face (drag, skid, snag, catch, poke, wedge, etc.), and/or interaction in a fracture network, such as at complex fracture junctions, narrowings of hydraulic fracture, and of course the ultimate property of residing or fixating in the fracture locale once treatment pumping has been completed and be functional by design and physical properties to suspend proppant particles.

It should also be appreciated that while one ribbon may be very capable of holding one or more proppant particles in place that it is expected that multiple fabrics will also catch, snag, collect, and otherwise engage with one another to support and catch one or more proppant particles to inhibit and/or prevent the proppant from settling due to gravity.

In one simple non-limiting embodiment the ribbons comprise a plurality of connected components or pieces.

With respect to the dimensions of the ribbons, it will be understood that the fractures each have at least two opposing fracture walls across a gap and where a ribbon singly, or a combination of ribbons, has at least one dimension that spans the gap between the opposing fracture walls or where multiple ribbons interconnected or entangled with one another spans the gap between the opposing fracture walls. In one non-limiting embodiment the ribbons comprise an average length of from about 0.1 inch independently to about 20 inches (about 0.25 to about 51 cm), alternatively from about 1.5 inch independently to about 15 inches (about 3.8 to about 38 cm), and in another non-limiting embodiment from about 2 inch independently to about 12 inches (about 5.1 to about 31 cm). The term “independently” as used with respect to a range means that any lower threshold may be combined with any upper threshold to give a suitable alternate range. As an example, a suitable alternative average ribbon length range would be from about 1.5 inch to about 15 inches.

The ribbons may have an average width of from about 0.05 inch independently to about 8 inch (about 1.3 mm to about 20 cm), alternatively from about 0.1 inch independently to about 4 inch (about 2.5 mm to about 10 cm), and in another non-limiting embodiment from about 0.2 inch independently to about 2 inch (about 5 mm to about 5.1 cm). The ribbons may have an average thickness of from about 0.002 inch independently to about 0.2 inch (about 0.05 mm to about 5 mm), alternatively from about 0.004 inch independently to about 0.16 inch (about 0.1 mm to about 4 mm), and in another non-limiting embodiment from about 0.008 inch independently to about 0.08 inch (about 0.2 mm to about 2 mm).

In one non-limiting embodiment a minimum aspect ratio of the ribbons is about 1 inch (2.5 cm) long by 0.2 inch (0.5 cm) wide by 0.1 inch (0.25 cm) thick, or about 5 to 1 to 0.5; or stated equivalently, 10:2:1. In another non-limiting embodiment, the minimum aspect ratio of length to width to thickness is about 50 to about 25 to about 1.

The loading or proportion of the ribbons in the treatment fluid, fracturing fluid or other carrier fluid, which may be water or brine, range from about 0.1 pounds per thousand gallons (pptg) independently to about 200 pptg (about 0.01 to about 24 kg/m³); from about 0.2 pptg independently to about 100 pptg (about 0.02 to about 12 kg/m³); from about 0.5 pptg independently to about 50 pptg (about 0.06 to about 6 kg/m³).

Further, as noted, the ribbons are a gel, such as a crosslinked gel, including but not necessarily limited to a crosslinked polysaccharide, such as a crosslinked guar, all of which are well known in the art. There may be selectively produced a High Viscosity Ratio Fluid (HVR Fluid) adapted for fracturing ultra-low permeability formations (i.e. coal seams, shales, and tight sands) as described in U.S. Patent Application Publication No. US 2014/0299326 A1, incorporated herein by reference in its entirety. Alternatively the ribbons may be made of other materials, including but not necessarily limited to plastic materials, including, but not necessarily limited to, thermoset polymers, such as hydrogels and include but are not limited to sodium polyacrylate and polyacrylamides.

Through use of an extrusion device a High Viscosity Material (HV Material) in the form of ribbons can be added to relatively lower viscosity fluid stream (e.g. the carrier fluid, brine water, etc.) during a frac treatment to create the HVR Fluid. The relatively lower viscosity fluid stream may be brine and/or slickwater. It is often referred to as brine herein, but it should be understood that the carrier fluid is not necessarily limited to brine. The HV Material size is typically very small so as to enter and flow in narrow width fractures, such as less than 1.0 mm in size, or other sizes as described above. In one non-limiting embodiment, the HV Material is at least 10 times more viscous than brine, alternatively at least 100 times more viscous than brine, and in a different non-limiting version at least 1000 time more viscous than brine, and typically is more than 100,000 time more viscous than brine at 0.01 sec⁻¹ shear rate at 80° F. (27° C.), or having other viscosity ratios as described below.

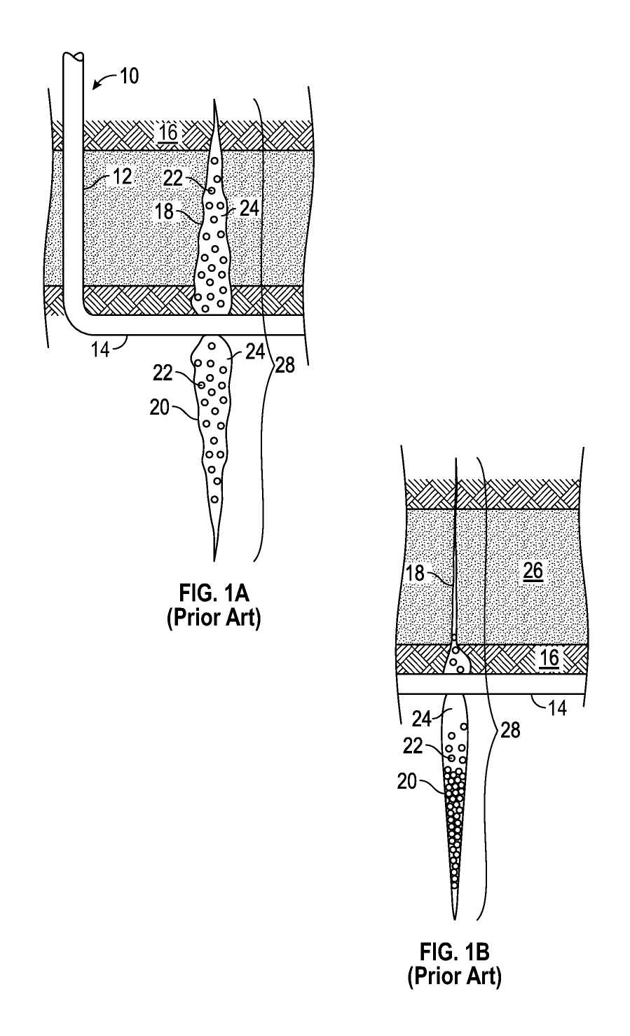

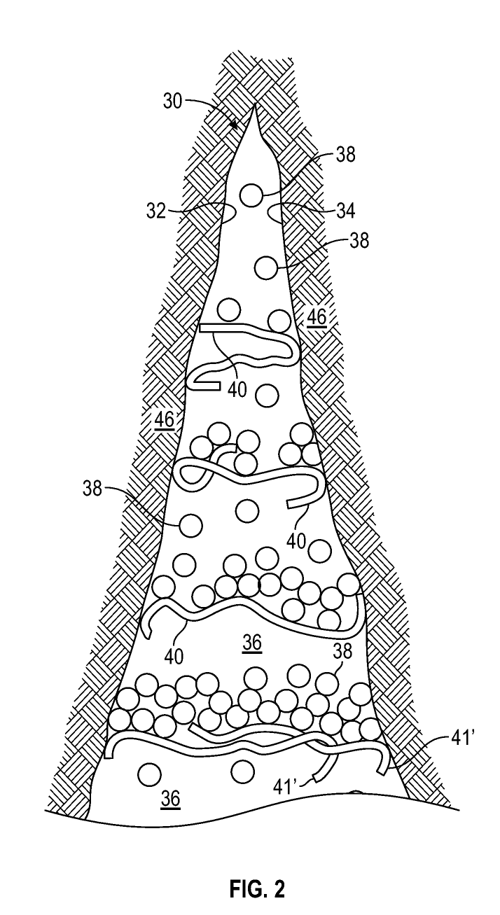

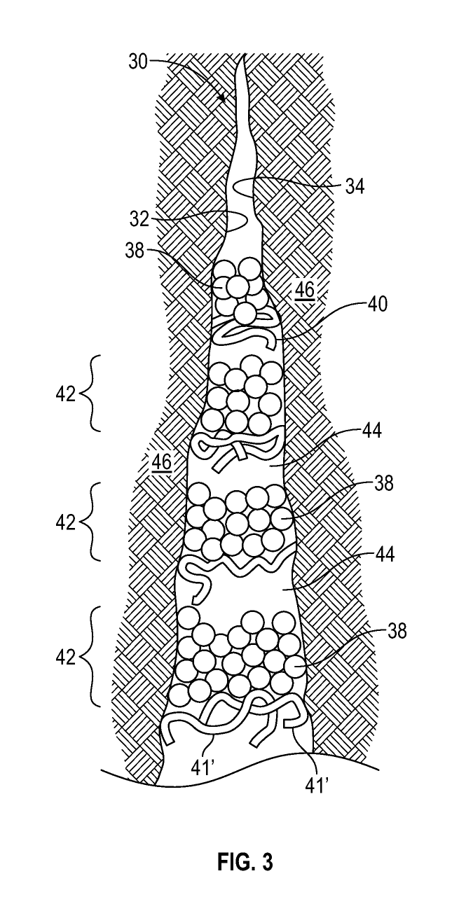

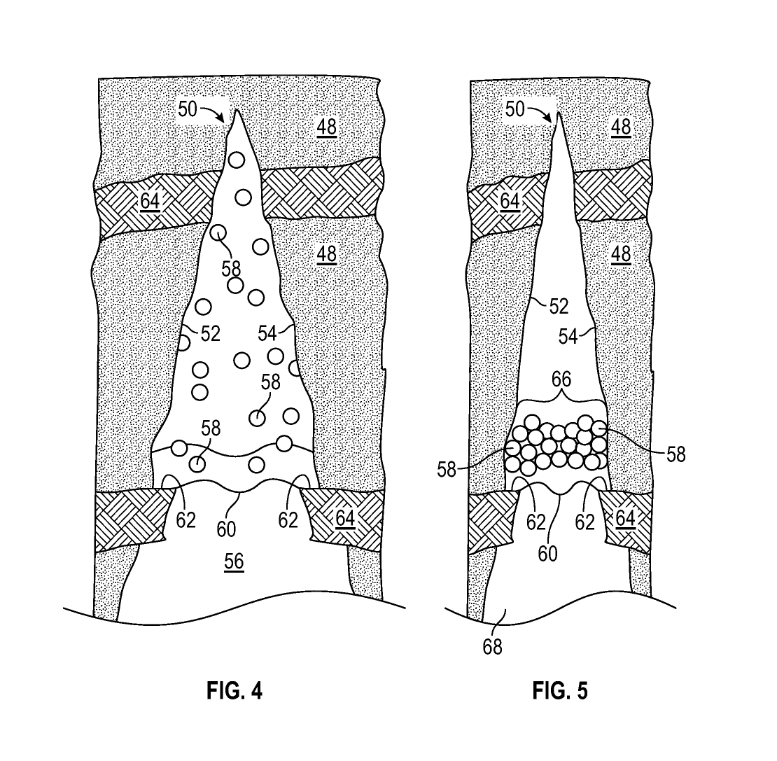

A wide range of viscous materials or gel technologies may be used to formulate the HV Material of the ribbons, including polymer and surfactant gels commonly used in the oilfield; for example in a non-limiting embodiment a 50 pptg borate crosslinked guar fluid system. An HV Material delivery device or apparatus is a mixer and/or additive tank with precision control for extruding viscous materials during a fracturing treatment, as shown in FIGS. 1 and 2 of US 2014/0299326 A1. Alternatively, the hydrogels may already be extruded. The hydrogels will hydrate in the presence of water and will have the high viscosity discussed herein. The device extrudes HV Materials of various shapes, sizes, compositions, and viscosity into brine during the treatment (see FIGS. 3 and 4 of US 2014/0299326 A1). This process can create a spectrum of HV ribbons. The HV Material effectively retains its size and shape in brine during wellbore pumping by the physical property that relatively much thinner, brine water has very poor shear energy transfer to small inclusions that have relatively very high viscosity at low shear rate. During the extrusion process the HV ribbons are introduced into the carrier fluid as discrete tiny masses with near-zero shear rate viscosity. Most formulations of HV Material will be highly elastic and deformable and will resist fluid-shear-induced fragmentation.

During a fracturing treatment, at the surface and within the wellbore the HVR Fluid will have brine-like fluid properties. The HVR Fluid may optionally have a friction reducer added to help reduced friction pressure (i.e. brine with conventional polyacrylamide friction reducers in an amount from about 0.25 to about 1 gptg; less than 5 pptg active polymer content). Depending on the size of the discrete HV Material bodies, in the planar (i.e. primary) fracture the HVR Fluid may still behave like brine water. Once the brine with discrete relatively highly viscous bodies and/or masses are within the hydraulic fractures with widths similar to or smaller than the HV Material ribbons, the HVR Fluid will initiate change in its flow properties. By controlling the viscosity and shear sensitivity of the HV Material ribbons, frictional interaction of the ribbons with the walls of narrow fractures will cause the HVR Fluid to transition from a brine-like fluid to a combination of brine and viscous ribbons having drag reduction and other fracture area and wall interaction properties. Once the HVR Fluid interacts with narrow hydraulic fractures the processes such as or similar to path of least resistance flow deviation, viscous material lodging in the fracture that produces reduced treatment fluid flow, total fluid diversion, in situ wall-shear induced fluid viscosity generation, and distribution of delayed released treatment additives can be engineered. Most of these processes will induce increased hydraulic fluid pressure (i.e. increased pressure drop within that specific region of the fracture). Increased fluid pressure may: a) reduce fluid flow in the fracture; b) increase fracture width, c) alter fracture extension, and eventually d) initiate creation of, and then flow in newly created fractures (i.e. induce fracture network complexity). During the treatment this fracture generating and fluid diversion process may be numerously repeated as an inherent characteristic of use of HVR Fluid.

Combined or incorporated with optional lightweight proppants, selectively sized and shaped discrete HV Material ribbons will better distribute the proppants in complex fracture networks. This use of discrete ribbons with proppant placement and distribution in the fracture network will increase fracture conductivity. That is, the proportion of nano-, micro-, and macro-darcy network conductivity from fracture tips to wellbore perforations may be more precisely controlled or engineered.

By “planar fracture” is meant the primary fracture that generally extends on either side of a wellbore in a bi-wing structure. Planar fractures generally follow a vertical plane in the formation. By “complex fracture” is meant the secondary fractures that generally occur at approximately right angles to the primary, planar fractures. It is known in the art that when fracturing ultra-low permeability reservoirs with slickwater the majority of fracture complexity (i.e. secondary, tertiary, etc.) occurs near the wellbore, particularly at lower treatment injection rates. A general trend with slickwater fracs is difficulty creating fracture complexity away from the wellbore; in other words, problems creating far-field complexity (i.e. away from the wellbore). Greater production of hydrocarbons may be achieved if fracture complexity (i.e. secondary, tertiary, etc.) occurs both near the wellbore and far-field.

Compositions, materials and devices are disclosed showing how to increase the generation and distribution of complex fractures in a formation, and increase transitional fracture conductivity, for instance by starting at the fracture tips create nanodarcy permeability to microdarcy permeability to millidarcy permeability to macrodarcy permeability in the numerous fractures leading to the wellbore.

A wide range of viscous materials may be used, including specially formulated polymer and surfactant gels commonly used in the oilfield, such as borate crosslinked guar and/or viscoelastic surfactant systems. Gelled hydrocarbons (e.g. gelled oils), viscous emulsions, viscous gelatins, viscoelastic polymeric fluids, vesicles, and other viscous fluid systems may also be used. The HV Material may be an aqueous or hydrocarbon based fluid or gel with a high resistance to flow (i.e. is highly viscous). The HV Material may also be materials of any kind with low water or low hydrocarbon content which permits them to become highly viscous during flow. Low water content in select HV Materials may be defined as: a) less than about 40% water; b) less than about 30%; and in some fluids less than about 20% water content by weight percent. Low liquid hydrocarbon content in select HV Materials may be defined as: a) less than about 60% liquid hydrocarbons; b) less than about 40%; and in some fluids less than about 30% liquid hydrocarbon content by weight percent. Suitable hydrocarbons may include, but are not limited to, alcohols, mineral oils, glycerin, glycols (including, but not necessarily limited to, mono-, di- and triethylene glycol), glycol ethers, d-limonene, terpenes, propylene and ethylene carbonates, and the like. The HV Material of the ribbons may also be an emulsion that is highly viscous during flow. In many cases the HV Material is viscoelastic during flow; however, the HV Material may have other rheological flow properties as long as it is capable to move by flow and exhibits high resistant to flow, having high centipoise fluid viscosity, as later specified. Non-limiting examples are low water content, but flowable, sugar solutions; low water content, but flowable, acid solutions; polysaccharides and other natural and synthetic polymer gels, doughs, gelatins, emulsions, gelled oils, and mixtures thereof. A non-limiting example of mixtures could be low water content sugars containing polysaccharide polymers.

In one non-limiting embodiment, the relatively high viscosity ribbons may have a viscosity ranging from about 100 independently to about 20,000,000 centipoise (cP) at 0.01 sec⁻¹ viscosity at 80° F. (27° C.); alternatively from about 10,000 independently to about 5,000,000 cP. The relatively low viscosity fluid, as noted, has a noticeably lower viscosity relative to the relatively high viscosity ribbon material. In another non-limiting embodiment, the relatively low viscosity fluid may have a viscosity ranging from about 1 independently to about 12 cP; alternatively from about 1.2 independently to about 6 cP at 0.01 sec⁻¹ viscosity at 80° F. (27° C.). In many cases, the viscosity of the relatively low viscosity fluid is Newtonian or with an added friction reducer is substantially Newtonian (greater than 90%) in flow behavior and is similar or close to the viscosity of water, low salinity brine (i.e. 2% KCI brine), high salinity completion brine, or formation brine.

In one non-limiting embodiment, the method to suspend proppant in shale fractures for creating a “pillar frac”, defined herein as a hydraulic fracture having a plurality of proppant pillars therein that hold the fracture open after fracture closure by removal of the hydraulic fluid pressure used to create the fracture. Custom formulated crosslinked gel can be mixed by a conventional Liquid Additive System (LAS) and a mixer on location. The resulting fluid will become a HVR Fluid as described herein. The crosslinked gel prepared at the mixer can be sent to an in-line motorized food industry dynamic extruder plate, as one non-limiting embodiment, for customized sizing, cutting, and/or shaping into shaped ribbons. Optionally the ribbons are wedge-shaped. The HV ribbons are then added to a treatment brine being sent to the high pressure pumps. During flow, the HV ribbons' length will be orientated with fluid flow. Upon treatment shutdown the ribbons will wedge within the fractures to collect settling proppants into dispersed pillars or piles. Of importance, the HV ribbons can be used in combination with “self-aggregating proppants” known in the art that spontaneously aggregate upon treatment shutdown and wedge within the fractures during settling. Other ways of forming the ribbons include, but are not necessarily limited to, associative polymerization or emulsion polymerization.

The HV ribbons can be used with brine in the early proppant stages (in one non-limiting embodiment, in 0.2 to 1 ppa proppant stages; where ppa refers to pound of proppant added—the number of pounds added to 1 gallon of clean base fluid). The HV ribbons could also be of use in the viscous fluid placing the proppant in the latter treatment stages. Mentioned again, it is suitable to use “self-aggregating proppants” that aggregate and wedge within the fracture upon shutdown and proppant settling. The HV ribbons may allow less viscosity to be used in the proppant stages and overall treatment to improve cleanup.

In further detail, the apparatus for forming the HVR fluid may be an on-location mixer, additive tank or injection apparatus that has precision control of extruding viscous materials, as shown in FIGS. 1 and 2 of US 2014/0299326 A1. The principle use of the apparatus is for the introduction of small, but relatively highly viscous material ribbons into relatively lower viscosity brine during the treatment to create a very high viscosity ratio (Vᵣ) treatment fluid mostly from materials common to the shale hydraulic fracturing industry. That is, to use current materials in smarter ways to derive greater benefits or performance. The possible benefits of the high viscosity contrast fluid (HVR Fluid) include, but are not necessarily limited to: 1) allowing water that does not have its bulk viscosity increased to be the principle hydraulic fluid; 2) uniquely delaying treatment fluid “viscosity effects” (when fluid exhibits a viscosity property); 3) controlling location (targeting) of where “increased treatment fluid viscosity effects” occurs; 4) using a process for significantly reducing the amount of viscous material used compared to current treatments; and 5) more efficiently using viscous material, in quantity and function; and the like.

The characteristics of the HV ribbons may be optimized by controlling initial: 1) viscosity, 2) low shear rate elasticity, 3) size; 4) shape; 5) combination of sizes and/or shapes; 6) concentration of ribbons to brine; 7) composition and density of brine; and 8) inclusion of treatment materials within the relatively high viscosity masses or bodies (like proppant, cleanup agent, clay control agent, breaker, tracer, and the like). Other characteristics may also be involved. The extrusion and injection apparatus may be configured for simultaneously providing several different HV Materials and inclusions during the frac treatment. More than one HV ribbon type may be used, and the ribbon types may vary in viscosity, composition, density, content, size, shape, concentration in the brine, and the like, for providing more versatility or wider range of fracture interaction when combined during a treatment. In one non-limiting example, when used independently, larger size and more viscous HV ribbons could be used to produce a HVR fluid for improving treatment fluid diversion from the planar fracture, where a second HV ribbon type can produce a HVR fluid better suited for fluid diversion within narrow secondary fractures, and a third HV ribbon type could be used to produce a HVR fluid better suited or customized (i.e. smaller in size and contain smaller proppants) for creating tertiary and beyond fracture complexity and transitional conductivity. The HV Material apparatus can be three or more reservoir tanks with one or more extrusion devices capable of varying the size, rate and the like of HV ribbon extrusion from each tank. Additionally, the rate of addition (amount of HV ribbon material added to brine over time) may vary linearly and/or in segments or may be pulses of high concentration followed by very low concentration cycles during material use. That is, the purposes of HVR Fluid use may be engineered and/or designed for particular points and times during a treatment.

There are multiple purposes for use of the ribbon materials and methods, which include but are not necessarily limited to: 1) partial diversion/flow deviation in fractures (paths of least resistance to flow in hydraulic fracture); 2) total fluid diversion from fracture (use of larger size, more viscous, and more numerous masses); 3) target placement and retention of proppant within the flow restrictive “choke points” in complex fracture networks; 4) delayed and targeted fluid viscosity—a type of in situ viscosity generation—that is, relatively low brine treatment fluid viscosity until specially formulated and sized viscosity material bodies encounter “confining wall shear” once they are within very narrow complex fractures (controlled by size, amount, and viscosity of material bodies); and 5) delayed release and improved distribution of treatment additives that are within the relatively high viscosity materials; and the like.

Use of these materials, fluids and apparatus should allow better treatment fluid diversion to improve the amount of surface area generated (increase the surface area ratio (Sᵣ) of complex fracture surface area (S_{cf}) to planar fracture surface area (S_{pf})). Use of these materials with proppants that are selectively sized and shaped for placement in complex fracture networks could improve transitional fracture conductivity (amount or proportion of nano-, micro-, and macro-darcy conductivity progressing from the fracture tips to wellbore perforations).

In another non-limiting embodiment, the methods described herein can take advantage of the nature of heterogeneous bedding planes within shale reservoirs which promote slight, but also small-to-moderate fracture width variations in primary hydraulic fractures. When combined with use of the ribbons described herein, the ribbons and procedures for using them can be configured into many placement and functional “ledge wedging” designs, and optionally combined with “self-aggregating proppants”.

A goal is to place ribbons with select size, shape, stiffness, conformation/geometry, and/or texture in the carrier fluid with the proppant during surface mixing that will “wedge” horizontally within the fracture during the treatment and/or once the treatment is completed. In one non-limiting embodiment, the treatment is a fracturing operation. Due to the flow conditions the ribbons will preferentially align lengthwise horizontally in the direction of flow. The length, width, stiffness, and configuration (in one non-restrictive shape, a slight spiral coil) of the ribbons can be optimized for the specific fracture width along with shale bedding and fracture roughness of the walls of the hydraulic fractures. Being stretched during flow, upon lowering of flow rate or stop pumping the horizontal ribbons will “wedge” in the hydraulic fracture and act as a platform for proppant settling to accumulate upon. Length, stiffness, width, and the amount of ribbons can be optimized to be wedged throughout the primary hydraulic fracture. The placement of the ribbons in the upper section of the hydraulic fracture would be helpful to improve height distribution of the proppant in the fracture (again, please see FIGS. 1A and 1B).

In one non-limiting embodiment, most primary fractures will be less than 8 mm in width, and some sections less than 5 mm wide. Additionally, each specific geographic shale lithology will have variations in each bedding lamination, such as lamination mineralogy, hardness, cleavage strength, roughness and angularity after hydraulic breakage, single lamination thickness, and the like which is more characteristic of real shale hydraulic fractures than common image conception of very smooth and consistent width straight primary fracture walls. The bedding variations themselves create to some scale horizontal “ledges” which proppant sedimentation will encounter. The specific characteristics of the ribbons can be such that they work even better with bedding ledges and fracture face roughness; see for instance the discussion of FIGS. 4 and 5. For example, ribbon edge texture roughness can be snagged or caught by fracture face irregularities. Other examples of fracture rock-ribbon interaction can be considered and utilized. The treatment can be designed with stop and go pump schedules to induce ribbon wedging in place, since frac fluid distribution may change during the proppant stages, taking into account factors including, but not necessarily limited to, fracture extension, fracture height, which perforation and fracture is taking most of the fracturing fluid at that point of the treatment, and the like). In one non-limiting embodiment, the combination of the method described herein with “self-aggregating proppants” that spontaneously form clusters at low shear and static conditions would improve the success of the ribbon wedge proppant deposition technology. The final distribution of the proppant can be such that many horizontal proppant beds or pillars and “tunnels” will be created. This type of proppant placement and conductivity geometry could be viewed as a form of tunnel fracturing and conductivity service. Another way of viewing this shale fracturing service could be as a “shale strata pack”.

In more detail, shown in FIG. 2 is a schematic illustration of an upper fracture 30 in subterranean formation 46, the fracture 30 having a first fracture face 32 and a second fracture face 34 generally opposing first fracture face 32. In the embodiment shown in FIG. 2, hydraulic fracturing fluid 36 is under hydraulic pressure, forming fracture 30, where first fracture face 32 and second fracture face 34 are separated at the greatest distance. In this non-restrictive version, hydraulic fracturing fluid 36 contains both a plurality of proppants 38 and a plurality of ribbons 40. As previously discussed, the ribbons 40 may be of the same length as one another, generally the same length as one another, or of different lengths from one another. In approximate the upper three-fourths of fracture 40, the ribbons 40 may span the entire distance between first fracture face 32 and second fracture face 34. However, in the lowest part of FIG. 2, two different ribbons 40 and 41′ are shown together intertwined and span the distance between first face 32 and second face 34.

As depicted in FIG. 2, the proppant 38 is at various stages of settling onto or being “caught” or suspended by various of the ribbons 40, thereby keeping the proppant more evenly, homogeneously and uniformly distributed in the vertical direction along fracture 40, and inhibiting or preventing undesirable banking of proppant as shown in the lower part of FIG. 1B previously discussed.

FIG. 3 is a schematic illustration of the upper fracture 30 of FIG. 2 after the fracturing fluid 36 pressure has been removed, the fracture 30 has closed, and proppant pillars 42 have been formed to prop open the fracture faces 32 and 34 away from one another to improve permeability. The proppant pillars are made up of the proppant 38, which optionally may be self-aggregating proppant. The pillars 42 may have ribbons 40 and 41′ contained therein in one non-limiting embodiment. Alternatively the ribbons 40 and 41′ may be removed by one or more of various mechanisms, including, but not limited to, hydrolysis. The pillars 42 can have tunnels 44 in between and around the pillars 42, which tunnels 44 increase the permeability of the subterranean formation 46.

Shown in FIG. 4 is a schematic illustration of an upper fracture 50 having a first fracture face 52 and an opposing, second fracture face 54, being fractured and held open by fracturing fluid 56 under pressure. Proppant 58 and a plurality of ribbons 60 are distributed in a fracturing fluid 56 under pressure therein and the proppants 58 are settling by gravity onto the ribbon 60, where the ribbon 60 is optionally wedged between ledges 62 on opposing fracture faces 52 and 54, and where optionally at least some of the proppants 58 are at least partially or entirely within the ribbon 60.

It will be appreciated that only one ribbon 60 is illustrated in FIG. 4, for the sake of simplicity; it is expected that many ribbons 60 will be placed within fracture 50 similarly to what is shown in FIGS. 2 and 3. It will be appreciated that a typical fracture 50 will have many strata 64 that form many ledges 62 upon fracturing, and that ribbons 60 will catch and snag on ledges 62, which then collect and proppant 58 thereon. Most of the proppant 58 illustrated in FIG. 4 are in the process of falling onto ribbon 60. It should be noted that in one non-limiting embodiment of the method the ribbon 60 may have proppant at least partially and/or completely, embedded therein prior to being wedged in fracture and/or caught on ledge 62. These ribbons 60 can be a gel as previously described, and the fracturing fluid 56 together with the gel ribbons 60 may be considered a HVR fluid.

Shown in FIG. 5 is fracture 50 after the hydraulic pressure of fracturing fluid 56 has been removed and the fracture 50 has been allowed to relax and first face 52 and second face 54 are allowed to approach one another. However, complete closure or collapse of fracture 50 is prevented by proppant pillar 66 formed by the proppant 58 that has collected on and/or within ribbon 60. Ribbon 60 is itself compressed when fracture 50 closes, but remains wedged between ledges 62 and maintains its prevention of the proppant 58 from falling by gravity further down closed fracture 50. Tunnels 68 may thus be formed on either side of pillar 66, which tunnels improve the permeability of subterranean formation 48 where fracture 50 is situated. Again, the pillar 66 may have ribbons 60 contained therein in one non-limiting embodiment. Alternatively, the ribbons 60 may be removed by one or more of various mechanisms, including, but not limited to, hydrolysis.

In one sense, the fracturing fluid 56 may be understood as having three main components: a relatively low viscosity continuous media fluid (e.g. brine), relatively high viscosity discontinuous masses, bodies or ribbons 60, and proppant 58. It will be appreciated that in some embodiments the ribbons 60 and the proppant 58 can be introduced separately from one another, and may be introduced after the hydraulic fracturing step, although it is expected that in one suitable embodiment all components will be introduced together and the hydraulic fracturing and ribbon and proppant placement will occur at about the same time.

It will be appreciated that the viscosity ratio Vᵣ will be designed to achieve the fracturing and production purposes of the methods described herein, that is, customized to a particular situation, which makes it difficult to specify a Vᵣ that is applicable for all applications. However, in one non-limiting embodiment the viscosity ratio Vᵣ of the 0.01 sec⁻¹ viscosity at 80° F. (27° C.) of the relatively higher viscosity material to the 0.01 sec⁻¹ viscosity at 80° F. (27° C.) of the relatively lower viscosity fluid stream ranges from about 10 independently to about 100,000; alternatively from about 100 independently to about 10,000; in another non-restrictive version from about 500 independently to about 5,000. In one non-limiting embodiment the crosslinked gel ribbons is the higher viscosity material and the fracturing fluid is the lower viscosity fluid stream.

Similarly, the size of the discrete ribbons or bodies will be designed to achieve fracturing and production purposes of the methods described herein, which may also be difficult to predict in advance. Nevertheless, to give an indication of the scale of the compositions herein, the discrete ribbons or bodies may have an average particle size from about 500 nm independently to about 50 cm; in one non-limiting embodiment 400 nm independently to about 30 mm, alternatively from about 1 μm independently to about 4 mm, and in another non-limiting embodiment about 10 μm independently to about 1 mm. It will be appreciated that the discrete ribbons or bodies may be formed by a process that does not give bodies that are the exact same size and/or shape, but which may be with a size range and/or a shape range.

Further, representative concentrations of the discrete ribbons or bodies in the relatively low viscosity fluid may range from about 0.1 vol % independently to about 20 vol %; alternatively range from about 0.2% vol % independently to about 5 vol %; alternatively range from about 0.25 vol % independently to about 2 vol %. The particular alternative range may vary due to the method of addition, if continuous or in slug or periodic high concentration fluid stages process of use.

The integrity of the extruded HV (high viscosity) Material to retain its size, shape, and the like during shear when being pumped downhole will depend on the viscosity, elasticity, and other properties of the HV Materials. Potentially the two most important HV Material properties will be extrusion size and amount of material viscosity for enduring high fluid shear during frac treatment placement. Another less controlling property is the density. The HV Material can be used in larger sizes with higher viscosity for providing complete fluid diversion downhole in fairly wide fracture widths; likewise the extruded HV Material can be very small in size and may only become active within very narrow fracture widths, so the HV Material activity may vary within the shale complex fracture network. A mixture of sizes and/or shapes may also be usefully employed.

It will be further appreciated that the extrusion, cutter and metering controller may be configured to be adjustable so that the rates of introduction and sizes of discrete ribbons or bodies may be readily changed. Referring to FIGS. 1 and 2 of U.S. Patent Application Publication No. 2014/0299326 A1, incorporated herein by reference in its entirety, apparatus 24 may comprise more than one reservoir 28, where each reservoir 28 has a respective extrusion conduit 32, drive mechanism 38, sizing cutter 38 and metering controller. In this manner, more than one type of discrete bodies 36, more than one size of discrete bodies 36, more than one shape of discrete bodies 36, and/or more than one composition of discrete bodies 36 may be introduced into the relatively low viscosity fluid 14 to give fracturing fluid 18. Additionally, the relatively high viscosity material 30 may be different for each reservoir 28. It will be appreciated that the higher the viscosity, the longer the discrete bodies 36 will keep their shape in fracturing fluid 18. However, it will also be appreciated that populations of discrete bodies 36 of different sizes or compositions will give a broader distribution of characteristics over time and distance during placement of fracturing fluid 18.

As mentioned, ribbons 60 and the like may contain dispersed proppant particles 58 as shown in FIG. 4. Suitably the proppants 58 will be unconventional in size and lightweight, having a specific gravity from about 0.9 independently to about 2.4, in another non-limiting embodiment about 1.0 independently to about 1.2. The smaller size will depend on the complex fracture widths for the particular lithology that is hydraulically fracture treated. In most cases the unconventional proppants will be less than 1 mm but larger than 10 microns. Conventional proppants 58 well known in the art in size and density may also be used in body 60, but most typically will be for the wider complex fractures and planar fracture to provide millidarcy to macrodarcy fracture conductivities. Composition of suitable proppants or propping agents 58 include, but are not limited to, for instance, quartz sand grains, glass beads, ceramic beads, bauxite beads or grains, walnut shell fragments, aluminum pellets, nylon pellets, resin pellets, other plastic pellets, composite pellets of various agents such as walnut shells and resin, nanomaterial coated proppants, and the like. Other additives may include, but are not necessarily limited to, piezoelectric particles, metal particles, metal complexes, metal salts, fines control agents, solid acids, solid high pH buffers, salts, chelants, oxidizers, plant and fish oils, mineral oils, shape memory polymers, fibers, glass spheres, encapsulations and combinations thereof.

It will be further appreciated that the compositions and methods for placement of unconventional and conventional proppants here will help create a transition of propped fracture conductivity from the fracture tip to the wellbore, starting with nanodarcy permeabilities at the fracture tips, to microdarcy permeabilities in the complex, secondary fractures to millidarcy to darcy permeabilities near the primary fracture, then to darcy to macrodarcy permeabilities within the primary propped fracture.

Thus, the methods, compositions and apparatus described herein involve the development of a “smart” fluid particularly adapted to hydraulically fracture shale, coal and tight formations. By use of a high viscosity internal phase material in the water phase, the fracturing fluid has initial properties of slick water and has higher viscosity properties once it is in select sections of the narrow width complex fractures network. The High Viscosity (HV) Material may be formed from a wide range of gel technology (e.g. crosslinked polymers (e.g. polysaccharides, etc., e.g. guar gum), VES, highly viscous emulsions and microemulsions, gelled oils, gelatins, and the like). The shape, size, viscosity, concentration, content, density, salinity, and the like may be adjusted to result in a fluid with a wide range of properties for varying widths and lengths of fractures.

More than one HV Material may be utilized for treating different fracture characteristics during the treatment. FIG. 1 of US 2014/0299326 A1 illustrates how a device can extrude and deliver the HV Material to brine on location. This fluid technology may be used for: a) low concentration in brine, inducing paths of least resistance flow deviation; b) improving complex fracture network proppant placement, particularly unconventional proppants; c) highly versatile fluid diversion; d) in situ viscosity generation; and e) distributing delayed release treatment additives. This technology is an alternative to conventional material diverters and may provide more versatile treatment designs and results. Each HV extruded Material-particle may contain viscosity breaker or be self-breaking under downhole conditions.

Additionally, alternative extrusion methods to create HVR Fluid may use different equipment and processes than those described above and in US 2014/0299326 A1. For example, HVR masses could be generated by sending highly viscous fluid through a centrifugal pump (or a more optimum shear and transfer device) followed by proportional injection or placement into the low viscosity treatment fluid (i.e. brine or slickwater) as a means to manufacture HVR Fluid. Another non-limiting example is one where HVR masses are generated by sending highly viscous fluid through a single fixed perforated plate with selectively sized and shaped holes and optionally passing the discrete bodies through a second in-line perforated plate with select holes geometry, followed by proportional addition into the low viscosity treatment fluid. In another non-limiting embodiment, the HVR masses may be extruded through one plate only, and as the extrudate emerges it is cut with a blade at regular (or even irregular) intervals. Proportional addition may occur just before placing the high viscosity ratio fluid composition in a residence tank, or shortly before or during the hydraulic fracturing treatment. These alternative methods may provide a balance between ease of manufacturing during the treatment and expense of equipment required, versus precision of the HVR masses that are incorporated into the low viscosity fluid to manufacture HVR Fluid. In other words, the use of alternative processes and equipment of manufacturing HVR Fluid that is easier, less expensive, and/or quicker to deliver to the hydraulic fracturing market or utilize in remote geographic locations.

In the foregoing specification, the invention has been described with reference to specific embodiments thereof, and has been demonstrated as effective in providing methods and apparatus for hydraulic fracturing in subterranean formations, particularly shale formations. However, it will be evident that various modifications and changes may be made thereto without departing from the invention as set forth in the appended claims. Accordingly, the specification is to be regarded in an illustrative rather than a restrictive sense. For example, specific combinations of relatively low viscosity fluids, relatively high viscosity materials, high viscosity ratio fluids, ribbons, proppants, and other additives are expected to be within the scope of this invention. Further, it is expected that the components and proportions of the various components may change somewhat from one application to another and still accomplish the stated purposes and goals of the compositions and methods described herein. For example, the compositions and methods may use different components, additives and additive/component combinations, different component proportions and additional or different steps than those described and exemplified herein.

The present invention may suitably comprise, consist or consist essentially of the elements disclosed and may be practiced in the absence of an element not disclosed. For instance, there may be provided a method of placing proppants in a hydraulic fracture of a subterranean formation, where the method consists essentially of or consists of hydraulically fracturing the subterranean formation to form fractures in the formation using a fracturing fluid, during and/or after hydraulically fracturing the subterranean formation, introducing proppants into the fractures, during and/or after hydraulically fracturing the subterranean formation, introducing a plurality of ribbons into the fractures, the ribbons contacting and inhibiting or preventing the proppant from settling by gravity within the fractures, where the ribbons comprise a gel, and closing the fractures against the proppants.

There may also be provided a fluid for placing proppants in a hydraulic fracture of a subterranean formation, where the fluid consists essentially of or consists of a carrier fluid, a plurality of proppants, and a plurality of ribbons configured to contact and inhibit or prevent the proppant from settling by gravity within hydraulic fractures in the subterranean formation, where the ribbons comprise a gel.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method of placing proppants in a hydraulic fracture of a subterranean formation, the method comprising:
hydraulically fracturing the subterranean formation to form fractures in the formation using a fracturing fluid;
during and/or after hydraulically fracturing the subterranean formation, introducing proppants into the fractures;
during and/or after hydraulically fracturing the subterranean formation, introducing a plurality of ribbons into the fractures, the ribbons contacting and inhibiting or preventing the proppant from settling by gravity within the fractures, where the ribbons comprise a gel; and
closing the fractures against the proppants.

2. The method of claim 1 where at least some of the proppants are aggregated on at least some of the ribbons.

3. The method of claim 2 where the proppants are self-aggregating.

4. The method of claim 1 where at least some of the proppants are contained at least partially within at least some of the ribbons.

5. The method of claim 1 where the ribbons comprise:
an average length of from about 0.1 inch to about 20 inches (about 0.25 to about 51 cm);
an average width of from about 0.05 inch to about 8 inch (about 1.3 mm to about 20 cm); and
an average thickness of from about 0.002 inch to about 0.2 inch (about 0.05 mm to about 5 mm).

6. The method of claim 1 where the gel ribbons are crosslinked polysaccharide gels.

7. The method of claim 1 where:
the fracturing fluid has a viscosity;
the ribbons have a viscosity; and
the viscosity ratio Vᵣ of the viscosity of the ribbons to the viscosity of the fracturing fluid ranges from 10 to 100,000.

8. The method of claim 1 where the ribbons have a minimum aspect ratio of length to width to thickness is about 50 to about 25 to about 1.

9. The method of claim 1 where introducing the ribbons into the fractures comprises employing a carrier fluid where a proportion of ribbons in the carrier fluid ranges from about 0.1 pptg to about 200 pptg (about 0.01 to about 24 kg/m³).

10. The method of claim 1 where closing the fractures against the proppants comprises creating a plurality of proppant pillars and a plurality of tunnels adjacent the proppant pillars.

11. A fluid for placing proppants in a hydraulic fracture of a subterranean formation, the fluid comprising:
a carrier fluid;
proppants; and
a plurality of ribbons configured to contact and inhibit or prevent the proppant from settling by gravity within hydraulic fractures in the subterranean formation, where the ribbons comprise a gel.

12. The fluid of claim 11 where the carrier fluid is a fracturing fluid.

13. The fluid of claim 11 where the proppants are self-aggregating.

14. The fluid of claim 11 where at least some of the proppants are contained at least partially within at least some of the ribbons.

15. The fluid of claim 11 where the ribbons comprise:
an average length of from about 0.1 inch to about 20 inches (about 0.25 to about 51 cm);
an average width of from about 0.05 inch to about 8 inch (about 1.3 mm to about 20 cm); and
an average thickness of from about 0.002 inch to about 0.2 inch (about 0.05 mm to about 5 mm).

16. The fluid of claim 11 where the gel ribbons are crosslinked polysaccharide gels.

17. The fluid of claim 11 where:
the carrier fluid has a viscosity;
the ribbons have a viscosity; and
the viscosity ratio Vᵣ of the viscosity of the ribbons to the viscosity of the fracturing fluid ranges from 10 to 100,000.

18. The fluid of claim 11 where the ribbons have a minimum aspect ratio of length to width to thickness is about 50 to about 25 to about 1.

19. The fluid of claim 11 where a proportion of ribbons in the carrier fluid ranges from about 0.1 pptg to about 200 pptg (about 0.01 to about 24 kg/m³).

20. A fluid for placing proppants in a hydraulic fracture of a subterranean formation, the fluid comprising:
a carrier fluid that is a fracturing fluid;
proppants; and
a plurality of ribbons configured to contact and inhibit or prevent the proppant from settling by gravity within hydraulic fractures in the subterranean formation, where the ribbons comprise a gel, and where the ribbons comprise:
an average length of from about 0.1 inch to about 20 inches (about 0.25 to about 51 cm);
an average width of from about 0.05 inch to about 8 inch (about 1.3 mm to about 20 cm); and
an average thickness of from about 0.002 inch to about 0.2 inch (about 0.05 mm to about 5 mm); and
where a proportion of ribbons in the carrier fluid ranges from about 0.1 pptg to about 200 pptg (about 0.01 to about 24 kg/m³).
